(19) United States
(12) Patent Application Publication
(10) Pub. No.: US 2025/0264139 A1
(43) Pub. Date: Aug. 21, 2025

(54) HOLDING DEVICE FOR ELECTROMECHANICAL VEHICLE BRAKE DEVICES

(71) Applicant: Robert Bosch GmbH, Stuttgart (DE)

(72) Inventors: Laszlo Boros, Ludwigsburg (DE); Simon Peter, Weil Der Stadt (DE)

(21) Appl. No.: 18/925,405

(22) Filed: Oct. 24, 2024

(30) Foreign Application Priority Data
Feb. 15, 2024 (DE) 10 2024 201 414.1

(51) Int. Cl. F16D 65/16; B60T 17/22; F16D 127/06

(52) U.S. Cl. CPC F16D 65/16; B60T 17/22; F16D 2127/06

(57) ABSTRACT

A holding device for electromechanical vehicle brake devices. The holding device includes a control device with a control program and at least one movably mounted plastic holding element. The element is configured, by means of the control device with the control program, to fix an electromechanical vehicle brake device, connected to the holding device, in at least one braking force holding position. The control device with the control program is configured to vary the end positions of the plastic holding element relative to the electromechanical vehicle brake that are necessary for the brake fixation process of the electromechanical vehicle brake device, so that consistent load conditions on the plastic holding element due to the brake fixation processes can be avoided during a total service life of the holding device.

### CROSS REFERENCE

The present application claims the benefit under 35 U.S.C. § 119 of German Patent Application No. DE 10 2024 201 414.1 filed on Feb. 15, 2024, which is expressly incorporated herein by reference in its entirety.

### FIELD

The present invention relates to a holding device for electromechanical vehicle brake devices.

### BACKGROUND INFORMATION

Customary electromechanical vehicle brake devices for conventionally operated vehicles with an internal combustion engine or for electrically operated vehicles typically use an electric motor with a rotary transmission and a rotary/translational converter to generate actuation forces for the friction brake. In rotary transmissions, the use of plastic gearwheels in individual gear stages (for example in worm gear stages) is a cost-effective solution, which provides, among other things, favorable NVH behavior (noise, vibration, harshness).

The transmissions of the electromechanical vehicle brake devices are generally not self-locking as a service brake so that an additional mechanism is required to hold the braking torque permanently during parking.

A particularly advantageous realization is an additional element in the transmission or on the electric motor, which blocks the rotation of these components in a positive fit. Conventional for this purpose are, for example, switchable freewheels or actuable pins that block rotation when the parking brake is being engaged.

Generally, these elements are mounted, if possible, in the highly translated part of the active chain, for example directly on the motor pinion, since the torques are lowest there, so that a particularly small and cost-effective implementation is possible.

In modularly constructed electromechanical vehicle brake devices, such assemblies can also be considered as a stand-alone unit. When using components made of plastic products, for example in the form of plastic gearwheels, a known problem is creep. The problem of creep can occur particularly if the locking mechanism for the parking function is arranged in front of the plastic gear stage in the transmission. This results in a strong static and consistent load on the plastic wheel during parking, in particular on one or a few teeth of the gearwheel, wherein this load can favor an unfavorable deformation due to said creep.

### SUMMARY

The present invention provides a holding device for electromechanical vehicle brake devices and a method for operating a holding device.

Furthermore, the present invention provides both an electromechanical vehicle disk brake device with a holding device according to the present invention and an electromechanical vehicle drum brake device with a holding device according the present invention.

Preferred developments of the present invention are disclosed herein.

The present invention specifies a holding device for electromechanical vehicle brake devices and a method for operating such a holding device, wherein a component of the holding device that is loaded during a brake fixation process of the electromechanical vehicle brake device assumes different end positions in different brake fixation processes so that consistent load conditions on the component due to the brake fixation processes can be avoided during a total service life of the holding device. Consistent end positions known in rigid systems from the prior art result in a highly static and consistent load on the holding element so that early material fatigue occurs over the total service life of the holding device, and smooth operation of brake fixation processes of the electromechanical vehicle brake device is consequently no longer ensured.

According to an example embodiment of the present invention, the holding device for electromechanical vehicle brake devices comprises a control device with a control program and at least one movably mounted plastic holding element. This element is configured, by means of the control device with the control program, to fix an electromechanical vehicle brake device, connected to the holding device, in at least one braking force holding position. Furthermore, the control device with the control program is configured to vary the end positions of the plastic holding element relative to the electromechanical vehicle brake that are necessary for the brake fixation process of the electromechanical vehicle brake device, so that consistent load conditions on the plastic holding element due to the brake fixation processes can be avoided during a total service life of the holding device.

The plastic holding element may comprise one or more plastic gearwheels.

The holding device may, for example, be advantageously used in any vehicle with an electromechanical vehicle brake device. In this context, the term “holding device” is to be understood with the holding forces to be provided for a sufficient parking torque, i.e., corresponding safe brake fixation processes, of the electromechanical vehicle brake device.

The varying end positions are provided in such a way that safe brake fixation processes of the electromechanical vehicle brake device are always ensured. In other words, the parking processes to be brought about by means of the presented holding device are always such that sufficient holding forces are set due to a corresponding end position of the plastic holding element in order to fix the vehicle in a safe parking position. A corresponding necessary end position is characterized in that braking torques above a threshold of a minimum parking brake torque required for a safe brake fixation process are ensured in each case, wherein the correspondingly necessary holding forces can be provided for this purpose due to a corresponding end position of the plastic holding element. The presented device of the present invention offers the advantage of varying the corresponding necessary end positions so that uniform load conditions on the plastic holding element can be avoided due to the different end positions that are set. In this way, an identical load condition on the plastic holding element can surprisingly simply be avoided during the brake fixation process of the electromechanical vehicle brake device so that a reliable and more durable mechanism can be provided. An always consistent end position of the plastic holding element for the purpose of providing sufficient holding forces for a safe brake fixation process can thus be avoided. The presented holding device is advantageously configured to provide a plurality of possible necessary end positions of the plastic holding element so that a variation from this plurality is possible so that consistent load conditions due to an always identical end position of the plastic holding element can be avoided.

According to a preferred embodiment of the holding device of the present invention, the plastic holding element is designed as a plastic gearwheel or as a worm gear device. The aforementioned advantages apply in the same way to this embodiment of the presented holding device. The corresponding necessary end positions to be varied result in a more even distribution of the load on the teeth of the plastic gearwheel or, correspondingly, in a more uniform load on portions of the worm gear device with respect to the total service life of the holding device.

According to a preferred embodiment of the holding device of the present invention, the corresponding end positions determined by means of the control device with the control program can be varied between a first end position with a minimum holding force for the brake fixation process of the electromechanical vehicle brake device and a second end position with a maximum holding force for the brake fixation process of the electromechanical vehicle brake device.

This ensures that the necessary end positions of the plastic holding element that are set are always in an interval that is vital for a safe and reliable brake fixation process of the electromechanical vehicle brake device.

Depending on the use of the presented holding device, this information can be set in the control device with the control program so that a reliable selection of necessary end positions from this interval is possible. The corresponding key values can also be considered as target values for the necessary end positions to be varied. In other words, the first and the second end position may also be variably approached in order to bring about a reliable brake fixation process of the electromechanical vehicle brake device.

According to a preferred embodiment of the holding device of the present invention, an end position of the plastic holding element that was selected by means of the control device with the control program differs from at least one directly previously used end position of the plastic holding element.

The directly previously used end position of the plastic holding element is to be derived from the last brake fixation process of the electromechanical vehicle brake device that was brought about by means of the holding device, and can accordingly be saved by the control device with the control program. This ensures that the necessary end positions vary sufficiently during the total service life of the holding device in order thus to avoid consistent load conditions.

According to a preferred embodiment of the holding device of the present invention, the control device with the control program is configured, depending on a user-defined settable time parking interval, to vary an already selected end position of the plastic holding element for a current brake fixation process of the electromechanical vehicle brake device toward at least one further end position that differs from the already selected end position.

It can thus be ensured that unfavorable consistent load conditions can be avoided even in the case of longer brake fixation processes of the electromechanical vehicle brake device. A user-defined settable time parking interval may, for example, correspond to a two-day parking period so that, after two days at the latest, another end position is brought about by means of the holding device in order to avoid said consistent load on the plastic holding element. A user-defined settable time parking interval is, for example, also settable such that the necessary end positions are regularly adjusted in the case of a longer parking period. In the case of longer parking phases, regular modulation of the necessary end positions is thus carried out. It is thus conceivable that, in the case of a very long standstill time of the vehicle in which the presented holding device is provided, the correspondingly necessary end positions are varied at regular intervals. In other words, it can thus be easily avoided that an unfavorable static and consistent load is set on the plastic holding element during longer parking phases of a vehicle that contains the presented mechanism.

According to a preferred embodiment of the holding device of the present invention, the control device with the control program is configured to vary the corresponding end positions with the aid of a random procedure.

Instead of, for example, a specified variation of the corresponding end positions for avoiding consistent load conditions, it can be easily ensured with the aid of the random procedure that sufficiently alternating end positions of the plastic holding element are thus set even over a longer total service life of the holding device so that consistent load conditions on the plastic holding element due to the brake fixation processes can be avoided during a total service life of the holding device.

According to a preferred embodiment of the holding device of the present invention, the control device comprises at least one actuator device for setting corresponding end positions of the plastic holding element relative to the electromechanical vehicle brake.

In this way, a particularly accurate and precise setting of the corresponding end positions can be ensured so that a greater number of possible end positions is available for the intended variable operating function. The actuator device may comprise all common mechanisms, such as a motor, necessary for the present embodiment. For example, the actuator device may comprise a component, which may, for example, be referred to as a parking element, which, as a type of ratchet pawl or switchable freewheel, can prevent currentless rotation of the actuator device. The plastic holding element is thus held in the corresponding end position by means of the control device and its particular design so that a built-up parking brake torque can also be held in the currentless state. Such a component can, for example, act on a corresponding pinion or the like of the actuator device for the purposes mentioned.

For engaging the parking brake, a defined current may, for example, be applied and/or a particular motor position may be approached and/or a particular actuation force may be applied (if measured by a sensor) and/or a particular braking torque may be applied (if measured by a sensor). When the brake is in the same condition, i.e., the same wear, the same thermal condition and coefficient of friction, all control types result in the motor and thus the gear position always being the same during parking. By changing the condition, e.g., wear over service life, the parking position changes only very slowly so that the same teeth of the plastic gearwheel are always highly loaded over a longer period of time during parking if the same position is always occupied.

In other words, at least according to one embodiment of the present invention, a more even distribution of the load on the teeth of the plastic gearwheel can be achieved by means of a software function, which randomizes the parking position of the motor above the required parking brake torque level and can thereby achieve different positions between different parking brake processes. Furthermore, during longer parking phases, the parking brake torque can be modulated at regular intervals and different positions can be approached. The modulation may, for example, be combined with known functions that are already performed when the vehicle is parked (e.g., hot reclamp/relax, operating strategy for preventing a release stroke).

According to an example embodiment of the present invention, an electromechanical vehicle disk brake device with a holding device according to the invention is also presented.

The aforementioned advantages apply in the same way to this presented subject matter. It is conceivable that the holding device, as a separate assembly, is appropriately functionally coupled to the electromechanical vehicle disk brake device. It is also conceivable that the holding device, as a functional subassembly, is already appropriately provided in the electromechanical vehicle disk brake device.

In addition, the present invention presents an electromechanical vehicle drum brake device with a holding device according to the present invention.

The aforementioned advantages apply in the same way to this presented subject matter. It is possible that the holding device, as a separate assembly, is appropriately functionally coupled to the electromechanical vehicle drum brake device. It is also possible that the holding device, as a functional subassembly, is already appropriately provided in the electromechanical vehicle drum brake device.

According to the present invention, in the method for operating a holding device according to the present invention, the following takes place: detecting a parking brake process of an electromechanical vehicle brake device by means of a holding device according to the invention; ascertaining a first end position of a plastic holding element of the holding device with a minimum holding force for a brake fixation process of the electromechanical vehicle brake device and a second end position of the plastic holding element of the holding device with a maximum holding force for the brake fixation process of the electromechanical vehicle brake device; selecting a current end position of the plastic holding element between the first and second end positions with the aid of a random procedure, wherein the selected current end position of the plastic holding element differs from at least one directly previously used end position of the plastic holding element so that consistent load conditions on the plastic holding element due to the fixation processes can be avoided during a total service life of the holding device.

The presented method offers the advantage of varying corresponding necessary end positions so that uniform load conditions on the plastic holding element can be avoided due to the different end positions that are set. In this way, an identical load condition on the plastic holding element can surprisingly simply be avoided during the brake fixation process of the electromechanical vehicle brake device so that a reliable and more durable mechanism can be provided.

According to a preferred embodiment of the method of the present invention, a temporal progression of a current brake fixation process of the electromechanical vehicle brake device is recorded; the current end position of the plastic holding element is changed, depending on a user-defined settable time parking interval, toward a new end position of the plastic holding element, which differs from the directly previous current end position of the plastic holding element, so that consistent load conditions on the plastic holding element due to a current brake fixation process of the electromechanical vehicle brake device can be avoided.

A temporal progression of the current brake fixation process of the electromechanical vehicle brake device begins when the necessary holding forces due to a corresponding end position of the plastic holding element are set so that a sufficient parking torque for a safe brake fixation process of the electromechanical vehicle brake device can be provided. The settable time interval may, for example, be selected such that a selected current end position is never maintained for so long that damage due to creeping processes in the material occurs due to the consistent load on the plastic holding element. A user-defined settable time parking interval is, for example, also settable such that the necessary end positions are regularly adjusted in the case of a longer parking period. In the case of longer parking phases, regular modulation of the necessary end positions is thus carried out. It is thus conceivable that, in the case of a very long standstill time of the vehicle in which the presented holding device is provided, the correspondingly necessary end positions are varied at regular intervals.

In other words, it can thus be easily avoided that an unfavorable static and consistent load on the plastic holding element is set during longer parking phases of a vehicle in which the presented method is used.

According to a further preferred embodiment of the method of the present invention, a temporal progression of a current brake fixation process of the electromechanical vehicle brake device is recorded; time-dependent material characteristic values of a plastic material of the plastic holding element are provided; the current end position of the plastic holding element is changed, depending on an evaluation of the time-dependent material characteristic values, toward a new end position of the plastic holding element, which differs from the directly previously current end position of the plastic holding element, so that consistent load conditions on the plastic holding element due to a current brake fixation process of the electromechanical vehicle brake device can be avoided.

A temporal progression of the current brake fixation process of the electromechanical vehicle brake device begins when the necessary holding forces due to a corresponding end position of the plastic holding element are set so that a sufficient parking torque for a safe brake fixation process of the electromechanical vehicle brake device can be provided. The evaluation of the time-dependent material characteristic values comprises, for example, model-based predictions of a creep behavior of the plastic material of the plastic holding element. When, for example, the temporal progression of the current brake fixation process of the electromechanical vehicle brake device reaches a point in time at which, according to the evaluation of the time-dependent material characteristic values, damage to the plastic holding element due to the creep behavior can be assumed or is at least sufficiently likely, a change toward another end position, i.e., a new end position that differs from the current end position, is brought about according to this preferred embodiment of the method so that consistent load conditions on the plastic holding element due to a current brake fixation process of the electromechanical vehicle brake device can be avoided.

The vehicle can thus be parked and held with a service brake actuator. A driver request “Parking” can be detected for this purpose. With a calculation of a desired parking brake level: (required parking brake level MP,req) and applying MP=MP,req+MP,rand (random portion) at time 1, where MP,rand is randomly selected between the minimum MP,req and a maximum value for parking MP,max. This varies the torque and thus the highly loaded teeth of the plastic wheel during each parking process. The torque MP is subsequently held by engaging the locking mechanism on the motor pinion until time 2.

Optionally, a new calculated torque can then be approached at time 2 and is in this case held until a time 3, for example. This step may be performed in the case of longer parking phases and may also be repeated regularly. The time 2 can be selected by means of a model-based prediction of the creep behavior of the plastic. For changing the parking brake levels, it may be necessary to actively release the parking ratchet pawl and to supply current to the service brake actuator system. This step may also be performed together with other control strategies that already require a “wake-up” of the vehicle and a move of the service brake. Examples in this respect are the known retightening of disk brakes during parking in order to compensate for a decreasing braking torque as a result of cooling (“hot reclamp”).

It is possible for the preferred embodiments of the method to also be applied and performed in any combination with one another.

The holding device can also be characterized by the features mentioned in connection with the method and by the advantages of the method, and vice versa.

Further features and advantages of embodiments of the present invention arise from the following description with reference to the figures.

### BRIEF DESCRIPTION OF THE DRAWINGS

The present invention is explained in greater detail below with reference to the embodiment examples indicated in the schematic figures.

FIG. 1 shows a schematic illustration of the holding device on an electromechanical vehicle brake device.

FIG. 2 shows an electromechanical vehicle disk brake device with a holding device according to an example embodiment of the present invention.

FIG. 3 shows an electromechanical vehicle drum brake device with a holding device according to an example embodiment of the present invention.

FIG. 4 shows a block diagram of method steps of the method for operating a holding device according to an example embodiment example of the present invention.

In the figures, identical reference signs denote identical or functionally identical elements.

### DETAILED DESCRIPTION OF EXAMPLE EMBODIMENTS

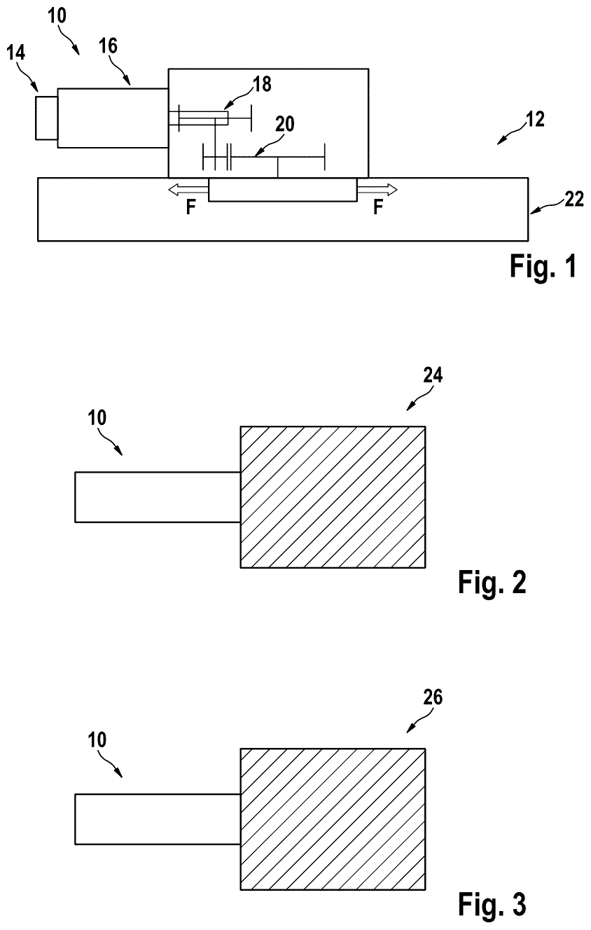

FIG. 1 shows a schematic illustration of the holding device 10 on an electromechanical vehicle brake device 12. In the present case, the electromechanical vehicle brake device 12 is shown as an electromechanically actuated drum brake. This combination may also be referred to as a transmission assembly with a parking brake mechanism.

The holding device 10 is shown with a control device with a control program and an actuator device 16. In addition, the holding device 10 is shown with a plastic holding element 18 in the form of a worm gear device. For example, such a worm gear device comprises at least one plastic worm gear. The plastic holding element 18 is attached to the actuator device 16 and is shown for the brake fixation process of the electromechanical vehicle brake device 12 in a possible necessary end position of the plastic holding element 18 relative to the electromechanical vehicle brake 12.

When current is supplied, an actuator device 16 as a motor can generate a rotational movement, which can be translated by the transmission (for example, two-stage with worm gear stage (made of plastic)+spur gear stage), and a force on the brake shoes can be generated by a rotary-translational converter. In the actuated state of the brake, the parking element 14 can then be engaged, e.g., by a second small actuator. By way of example, the parking element 14 could be a pin that is actuated by a coil, and the motor shaft (in the approached state) can be blocked by the pin, for example, blocking a ratchet wheel on this shaft. The current feed of the motor 16 can subsequently be turned off since the position is held by the parking element. The parking element itself can be designed to remain in the engaged position even if the current feed is removed from the small parking actuator. For example, this may be achieved by friction between pin and ratchet wheel or a bistable spring.

This assembly may result in the entire torque necessary for parking being permanently held via the plastic transmission element (worm gear stage). In order to avoid or reduce creep at this point, the operating strategy is proposed accordingly.

For example, a ratchet pawl or a switchable freewheel may be provided, wherein these elements can also each be referred to as a parking element. An active release of this component then results in the plastic holding element being able to be released for intended variations. In any case, the control device is in each case configured such that a necessary torque for a parking process can be held by means of said control device, either directly in connection with the plastic holding element or in connection with the actuator device and the parking element.

In addition, a built-up parking brake torque can be held by the plastic holding element 18, which is shown in FIG. 1 in a highly simplified manner by the coupling to a spur gear stage 20 of the electromechanical vehicle brake device 12. In the case of parking, the necessary actuation force F for parking must be permanently applied to brake shoes in a brake drum 22 of the electromechanical vehicle brake device 12. This creates torques that must also be held, among other things, or must only be held exclusively by the plastic holding element 18. In a toothing, the forces are typically transferred only by a small portion of the teeth. When the corresponding end positions are not varied, this results in a high static load on the plastic teeth, which can result in creep in the long run.

Since necessary end positions of the plastic holding element 18 can be varied while maintaining sufficient function for the brake fixation process of the electromechanical vehicle brake device 12, consistent load conditions can be avoided. For example, by means of the presented holding device 10, a braking torque in a parking process of a vehicle in which the holding device 10 is provided can be randomly varied above a threshold of the minimum parking brake torque necessary for parking.

The differing corresponding necessary end positions of the plastic holding element 18 may also be referred to as corresponding parking brake levels. For changing a current parking brake level, it may be necessary to actively release the plastic holding element and simultaneously supply current to a service brake actuator system of the electromechanical vehicle brake device 12.

FIG. 2 shows an electromechanical vehicle disk brake device 24 with a holding device 10 according to the invention.

FIG. 3 shows an electromechanical vehicle drum brake device 26 with a holding device 10 according to the invention.

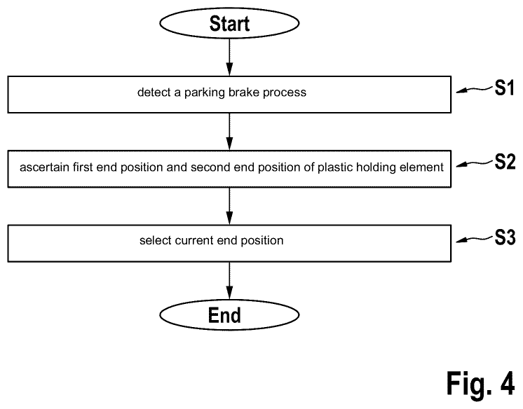

FIG. 4 shows a block diagram of method steps of the method for operating a holding device according to an embodiment example of the present invention.

In the method for operating a holding device according to the invention according to one of claims 1 to 7, the following takes place: detecting S1 a parking brake process of an electromechanical vehicle brake device by means of a holding device according to the invention; ascertaining S2 a first end position of a plastic holding element of the holding device with a minimum holding force for a brake fixation process of the electromechanical vehicle brake device and a second end position of the plastic holding element of the holding device with a maximum holding force for the brake fixation process of the electromechanical vehicle brake device; selecting S3 a current end position of the plastic holding element between the first and second end positions with the aid of a random procedure, wherein the selected current end position of the plastic holding element differs from at least one directly previously used end position of the plastic holding element so that consistent load conditions on the plastic holding element due to the fixation processes can be avoided during a total service life of the holding device.

The presented method may be carried out, at least in part or even in total, together with further control strategies which already require a so-called wake-up of the vehicle and an associated move of the service brake. Examples in this respect are the known so-called retightening of disk brakes during parking processes in order to compensate for decreasing braking torques caused, for example, by cooling processes, also known by the technical term “hot reclamp.” In the context of drum brakes, the so-called “hot relax” function should also be mentioned, for example. A combination, at least in part or even in total, with methods that provide for regularly releasing the parking brake in order to avoid a release stroke in drum brakes may also be provided.

Although the present invention has been completely described above with reference to the preferred embodiment example, it is not limited thereto but can be modified in many ways.

What is claimed is:

1. A holding device for an electromechanical vehicle brake device, comprising:
a control device with a control program; and
at least one movably mounted plastic holding element, which is configured to fix, using the control device with the control program, an electromechanical vehicle brake device, connected to the holding device, in at least one braking force holding position, wherein the control device with the control program is configured to vary end positions of the plastic holding element relative to the electromechanical vehicle brake that are necessary for the brake fixation process of the electromechanical vehicle brake device, so that consistent load conditions on the plastic holding element due to the brake fixation processes can be avoided during a total service life of the holding device.

2. The holding device according to claim 1, wherein the plastic holding element is a plastic gearwheel or a worm gear device.

3. The holding device according to claim 1, wherein the end positions determined using the control device with the control program can be varied between a first end position with a minimum holding force for the brake fixation process of the electromechanical vehicle brake device and a second end position with a maximum holding force for the brake fixation process of the electromechanical vehicle brake device.

4. The holding device according to claim 1, wherein an end position of the plastic holding element that was selected by using the control device with the control program differs from at least one directly previously used end position of the plastic holding element.

5. The holding device according to claim 1, wherein the control device with the control program is configured, depending on a user-defined settable time parking interval, to vary an already selected end position of the plastic holding element for a current brake fixation process of the electromechanical vehicle brake device toward at least one further end position that differs from the already selected end position.

6. The holding device according to claim 1, wherein the control device with the control program is configured to vary the end positions using a random procedure.

7. The holding device according to claim 1, wherein the control device includes at least one actuator device configured to set the end positions of the plastic holding element relative to the electromechanical vehicle brake.

8. An electromechanical vehicle disk brake device, comprising:
a holding device including:
a control device with a control program, and
at least one movably mounted plastic holding element, which is configured to fix, using the control device with the control program, an electromechanical vehicle brake device, connected to the holding device, in at least one braking force holding position, wherein the control device with the control program is configured to vary end positions of the plastic holding element relative to the electromechanical vehicle brake that are necessary for the brake fixation process of the electromechanical vehicle brake device, so that consistent load conditions on the plastic holding element due to the brake fixation processes can be avoided during a total service life of the holding device.

9. An electromechanical vehicle drum brake device, comprising:
a holding device including:
a control device with a control program, and
at least one movably mounted plastic holding element, which is configured to fix, using the control device with the control program, an electromechanical vehicle brake device, connected to the holding device, in at least one braking force holding position, wherein the control device with the control program is configured to vary end positions of the plastic holding element relative to the electromechanical vehicle brake that are necessary for the brake fixation process of the electromechanical vehicle brake device, so that consistent load conditions on the plastic holding element due to the brake fixation processes can be avoided during a total service life of the holding device.

10. A method for operating a holding device, comprising the following steps:
detecting a parking brake process of an electromechanical vehicle brake device that uses a holding device;
ascertaining a first end position of a plastic holding element of the holding device with a minimum holding force for a brake fixation process of the electromechanical vehicle brake device and a second end position of the plastic holding element of the holding device with a maximum holding force for the brake fixation process of the electromechanical vehicle brake device; and
selecting a current end position of the plastic holding element between the first and second end positions with the aid of a random procedure, wherein the selected current end position of the plastic holding element differs from at least one directly previously used end position of the plastic holding element so that consistent load conditions on the plastic holding element due to the fixation processes can be avoided during a total service life of the holding device.

11. The method according to claim 10, further comprising the following steps:
recording a temporal progression of a current brake fixation process of the electromechanical vehicle brake device; and
changing, depending on a user-defined settable time parking interval, the current end position of the plastic holding element toward a new end position of the plastic holding element, which differs from the directly previously current end position of the plastic holding element, so that consistent load conditions on the plastic holding element due to a current brake fixation process of the electromechanical vehicle brake device can be avoided.

12. The method according to claim 10, further comprising the following steps:
recording a temporal progression of a current brake fixation process of the electromechanical vehicle brake device;
providing time-dependent material characteristic values of a plastic material of the plastic holding element; and
changing, depending on an evaluation of the time-dependent material characteristic values, the current end position of the plastic holding element toward a new end position of the plastic holding element, which differs from the directly previously current end position of the plastic holding element, so that consistent load conditions on the plastic holding element due to a current brake fixation process of the electromechanical vehicle brake device can be avoided.
